(19) United States
(12) Patent Application Publication
(10) Pub. No.: US 2022/0207081 A1
(43) Pub. Date: Jun. 30, 2022

(54) IN-VEHICLE MUSIC SYSTEM AND METHOD

(71) Applicant: Volvo Car Corporation, Goteborg (SE)

(72) Inventor: Sihao Ding, Sunnyvale, CA (US)

(21) Appl. No.: 17/138,998

(22) Filed: Dec. 31, 2020

(51) Int. Cl. G06F 16/635; G06K 9/00; G06N 3/04; G06F 3/16; G06F 16/687; B60K 37/02

(52) U.S. Cl. CPC G06F 16/635; G06K 9/00832; G06N 3/04; G06F 3/167; B60K 2370/21; B60K 37/02; B60K 2370/148; B60K 2370/164; G06F 16/687

(57) ABSTRACT

The present disclosure provides an in-vehicle music system and method that leverages current external cameras, interior cameras, interior microphones, global positioning system (GPS) and navigation maps, artificial intelligence (AI) systems, and the like to provide driving pace-adapted music, external location, scene, weather, and road condition-adapted music, interior noise-adapted music, driver mood-adapted music, and big data-trained personalized playlists taking these functionalities into account.

### TECHNICAL FIELD

The present disclosure relates generally to the automotive field. More particularly, the present disclosure relates to an in-vehicle music system and method.

### BACKGROUND

Numerous conventional vehicles utilize automatic volume control, whereby sound system (including satellite and terrestrial radio) volume is adjusted based on vehicle speed. This maintains a relatively constant sound system volume-to-interior noise ratio, enhancing the driver and passenger experience. When the vehicle is moving a low rate of speed, the sound system volume is relatively lower. When the vehicle is moving at a high rate of speed, the sound system volume is relatively higher. This functionality is enabled by knowledge of the vehicle's speed based on a speedometer or electronic control unit (ECU) link. Such functionality is fairly simplistic.

Many newer vehicles are equipped with external cameras, interior cameras, interior microphones, and artificial intelligence (AI) systems. These external cameras and AI systems are operable for enabling autonomous driving (AD) and driver assistance (DA) systems that are capable of alerting drivers to objects surrounding a vehicle, assessing road conditions surrounding a vehicle, and performing automatic driving maneuvers, for example. These interior cameras and AI systems are operable for observing driver out-of-the-loop conditions, providing appropriate driver alerts, and performing automatic driving maneuvers, for example. These interior microphones and AI systems are operable for receiving voice commands from a driver or passenger, for example. To date, however, these devices and functionalities have not been leveraged to enhance driver and passenger experience features.

It should be noted that this background is provided as illustrative context and environment only. It will be readily apparent to those of ordinary skill in the art that the principles of the present disclosure may be applied in other contexts and environments equally.

### SUMMARY

The present disclosure provides an in-vehicle music system and method that leverages current external cameras, interior cameras, interior microphones, global positioning system (GPS) and navigation maps, AI systems, and the like to provide driving pace-adapted music, external location, scene, weather, and road condition-adapted music, interior noise-adapted music, driver mood-adapted music, and big data-trained personalized playlists taking these functionalities into account.

In one illustrative embodiment, the present disclosure provides a system, including: an external camera coupled to a vehicle; an interior camera coupled to the vehicle; an interior microphone coupled to the vehicle; an artificial intelligence system coupled to the external camera, the interior camera, and the interior microphone operable for determining one or more of an environmental context surrounding the vehicle, an occupant state inside the vehicle, and a noise condition inside the vehicle based on one or more of an external image obtained from the external camera, an interior image obtained from the interior camera, and a sound signal obtained from the interior microphone; and a recommendation system operable for making a music suggestion and controlling a volume of a sound system of the vehicle based on the one or more of the environmental context surrounding the vehicle, the occupant state inside the vehicle, and the noise condition inside the vehicle determined by the artificial intelligence system. The system further includes a global positioning and navigation system coupled to the vehicle, wherein the recommendation system is further operable for making the music suggestion and controlling the volume of the sound system of the vehicle based on a position of the vehicle determined by the global positioning and navigation system. The recommendation system is operable for making the music suggestion based on the one or more of the environmental context surrounding the vehicle, the occupant state inside the vehicle, and the noise condition inside the vehicle using one or more of tagged music from an occupant playlist and a public playlist. The recommendation system is further operable for receiving an acceptance or rejection of the music suggestion made by the recommendation system via one or more of an audible occupant command and an occupant command entered using a graphical user interface. The recommendation system is further operable for playing the music suggestion via the sound system if accepted by an occupant. The recommendation system is further operable for adding the music suggestion to an occupant playlist if accepted by an occupant. The artificial intelligence system includes a trained neural network.

In another illustrative embodiment, the present disclosure provides a method, including: obtaining an external image using an external camera coupled to a vehicle; obtaining an interior image using an interior camera coupled to the vehicle; obtaining an audio signal using an interior microphone coupled to the vehicle; determining one or more of an environmental context surrounding the vehicle, an occupant state inside the vehicle, and a noise condition inside the vehicle based on one or more of the external image obtained from the external camera, the interior image obtained from the interior camera, and the sound signal obtained from the interior microphone using an artificial intelligence system coupled to the external camera, the interior camera, and the interior microphone; and making a music suggestion and controlling a volume of a sound system of the vehicle based on the one or more of the environmental context surrounding the vehicle, the occupant state inside the vehicle, and the noise condition inside the vehicle determined by the artificial intelligence system using a recommendation system. The method further includes making the music suggestion and controlling the volume of the sound system of the vehicle using the recommendation system based on a position of the vehicle determined by a global positioning and navigation system coupled to the vehicle. The method further includes making the music suggestion based on the one or more of the environmental context surrounding the vehicle, the occupant state inside the vehicle, and the noise condition inside the vehicle using the recommendation system and one or more of tagged music from an occupant playlist and a public playlist. The method further includes receiving an acceptance or rejection of the music suggestion made by the recommendation system via one or more of an audible occupant command and an occupant command entered using a graphical user interface. The method further includes playing the music suggestion via the sound system if accepted by an occupant. The method further includes adding the music suggestion to an occupant playlist if accepted by an occupant.

In a further illustrative embodiment, the present disclosure provides a non-transitory computer-readable medium including instructions stored in a memory and executed by a processor to carry out the steps, including: obtaining an external image using an external camera coupled to a vehicle; obtaining an interior image using an interior camera coupled to the vehicle; obtaining an audio signal using an interior microphone coupled to the vehicle; determining one or more of an environmental context surrounding the vehicle, an occupant state inside the vehicle, and a noise condition inside the vehicle based on one or more of the external image obtained from the external camera, the interior image obtained from the interior camera, and the sound signal obtained from the interior microphone using an artificial intelligence system coupled to the external camera, the interior camera, and the interior microphone; and making a music suggestion and controlling a volume of a sound system of the vehicle based on the one or more of the environmental context surrounding the vehicle, the occupant state inside the vehicle, and the noise condition inside the vehicle determined by the artificial intelligence system using a recommendation system. The steps further include making the music suggestion and controlling the volume of the sound system of the vehicle using the recommendation system based on a position of the vehicle determined by a global positioning and navigation system coupled to the vehicle. The steps further include making the music suggestion based on the one or more of the environmental context surrounding the vehicle, the occupant state inside the vehicle, and the noise condition inside the vehicle using the recommendation system and one or more of tagged music from an occupant playlist and a public playlist. The steps further include receiving an acceptance or rejection of the music suggestion made by the recommendation system via one or more of an audible occupant command and an occupant command entered using a graphical user interface. The steps further include playing the music suggestion via the sound system if accepted by an occupant. The steps further include adding the music suggestion to an occupant playlist if accepted by an occupant. The artificial intelligence system includes a trained neural network.

### BRIEF DESCRIPTION OF THE DRAWINGS

The present disclosure is illustrated and described with reference to the various drawings, in which like reference numbers are used to denote like system components/method steps, as appropriate, and in which:

FIG. 1 is a schematic diagram of one illustrative embodiment of the in-vehicle music system of the present disclosure;

FIG. 2 is a schematic diagram illustrating the GPS and navigation map functionality of the in-vehicle music system of the present disclosure;

FIG. 3 is a schematic diagram illustrating the recommendation system functionality of the in-vehicle music system of the present disclosure;

FIG. 4 is a network diagram of a cloud-based system for implementing the various algorithms and services of the present disclosure;

FIG. 5 is a block diagram of a server that may be used in the cloud-based system of FIG. 4 or stand-alone; and

FIG. 6 is a block diagram of a user device that may be used in the cloud-based system of FIG. 4 or stand-alone.

### DESCRIPTION OF ILLUSTRATIVE EMBODIMENTS

Again, the present disclosure provides an in-vehicle music system and method that leverages current external cameras, interior cameras, interior microphones, GPS and navigation maps, AI systems, and the like to provide driving pace-adapted music, external location, scene, weather, and road condition-adapted music, interior noise-adapted music, driver mood-adapted music, and big data-trained personalized playlists taking these functionalities into account.

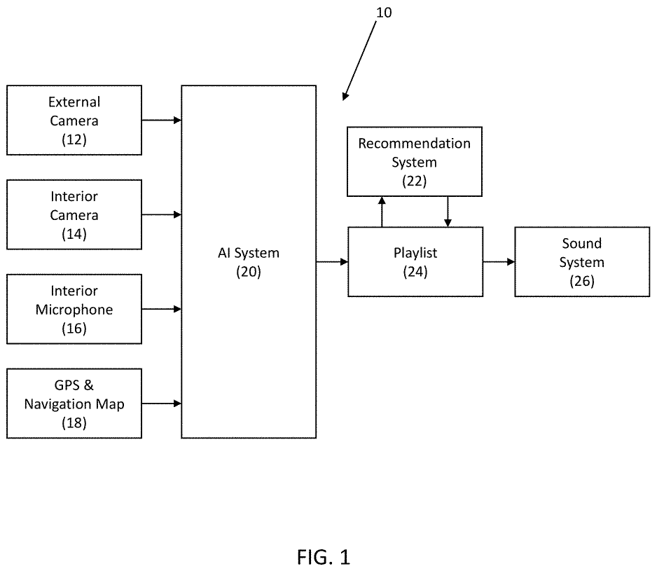

FIG. 1 is a schematic diagram of one illustrative embodiment of the in-vehicle music system 10 of the present disclosure. In general, the in-vehicle music system 10 includes the external camera(s) 12 of the vehicle, the interior camera(s) 14 of the vehicle, the interior microphone(s) 16 of the vehicle, and the GPS and navigation map(s) 18 of the vehicle, all of which provide input to an AI system 20 that provides the adaptive logic of the in-vehicle music system 10. Again, many newer vehicles are equipped with such external cameras 12, interior cameras 14, interior microphones 16, and such AI systems 20. These external cameras 12 and AI systems 20 are operable for enabling AD and DA systems that are capable of alerting drivers to objects surrounding a vehicle, assessing road conditions surrounding a vehicle, and performing automatic driving maneuvers, for example. These interior cameras 14 and AI systems 20 are operable for observing driver out-of-the-loop conditions, providing appropriate driver alerts, and performing automatic driving maneuvers, for example. These interior microphones 16 and AI systems 20 are operable for receiving voice commands from a driver or passenger, for example. To date, however, these devices and functionalities have not been leveraged to enhance driver and passenger experience features.

Here, the above in-vehicle music system components 12, 14, 16, 18, 20 are operable for using external inputs to make music suggestions, adjust volume levels, etc. in an automated manner based on observed environmental context. As is conventional, the AI system 20 utilizes a neural network (NN), such as a convolutional neural network (CNN), that is trained to segment and annotate images and/or identify sounds based on experiential learning. The present disclosure is agnostic related to these AI methodologies, and any suitable AI methodologies may be utilized equally. Based on the observed environmental context, the AI system 20 and a coupled recommendation system 22 make music suggestions and suggest or set an appropriate volume level using tagged suggestions from a user's playlist 24, available from a user's mobile device or the like, or tagged suggestions from a larger database forming part of the recommendation system 22. Such outside suggestions can then be added to or subtracted from the user's playlist 24 based on expressed user preferences (verbal or inputted via a graphical user interface (GUI)), and ultimately promulgated to the mobile device or the like. Ultimately, the environmental context appropriate music is broadcast via the sound system and speaker(s) 26 in the vehicle.

By way of example only, the in-vehicle music system 10 can be used to suggest rock music at louder volume when driving in an identified urban area or on a highway, or classical music at a softer volume when driving in an identified rural area or beautiful snowy conditions. The volume may be turned up proportionally when interior engine/motor or air conditioning (AC) fan noise is identified, or turned down proportionally when interior conversation is identified. Thus, the in-vehicle music system 10 can be used to set an appropriate mood for observed driving conditions, or respond to observed environmental conditions for convenience and safety. For example, if the external camera(s) 12 and/or interior microphone(s) 16 identify and emergency situation via lights, sirens, and/or the sound of an impact event, the music volume may be turned down or the music stopped, such that driver attention is promoted. In the case that contextual music suggestions are provided, the user's playlist may be expanded or contracted based on expressed user preferences.

The external camera(s) 12 may include front facing, rear facing, side facing, and/or bird's-eye-view (BEV) cameras, as well as other external perception sensors, such as radar and lidar. The recommendation system 22 utilizes tagged lists of music, with appropriate environmental context known in advance, whether in the recommendation system database or in the user's playlist 24. Volume control is provided on a proportional basis based on observed interior/external volume and/or identified sounds. The external camera(s) 12 utilize known computer vision (CV) and deep learning (DL) algorithms applied to the obtained images. This enables both object and scenario detection, as well as road condition detection—is the scene urban, rural, a highway, a country road, a mountain, a seashore, a bridge; is the road clear, wet, slippery, is there an accident or an emergency vehicle; etc.? The interior camera(s) 14 and interior microphone(s) 16 utilize known CV, computer hearing (CH), and DL algorithms applied to the obtained images and sounds. This enables both interior and external situational awareness—is the driver sleepy, excited, conversing, on the phone; is the vehicle noisy; is there and accident or emergency vehicle; etc.? The AI system 20 and recommendation system 22 can be used to set an appropriate mood or more effectively capture the driver's attention, thereby relaxing the driver or promoting greater safety. Thus, the interior microphone(s) 16 and associated software implement machine learning (ML) and natural language processing (NLP) algorithms to audio signals to increase volume responsive to certain high ambient noise levels, decrease volume responsive to certain high ambient noise levels, and decrease volume responsive to certain identified noises.

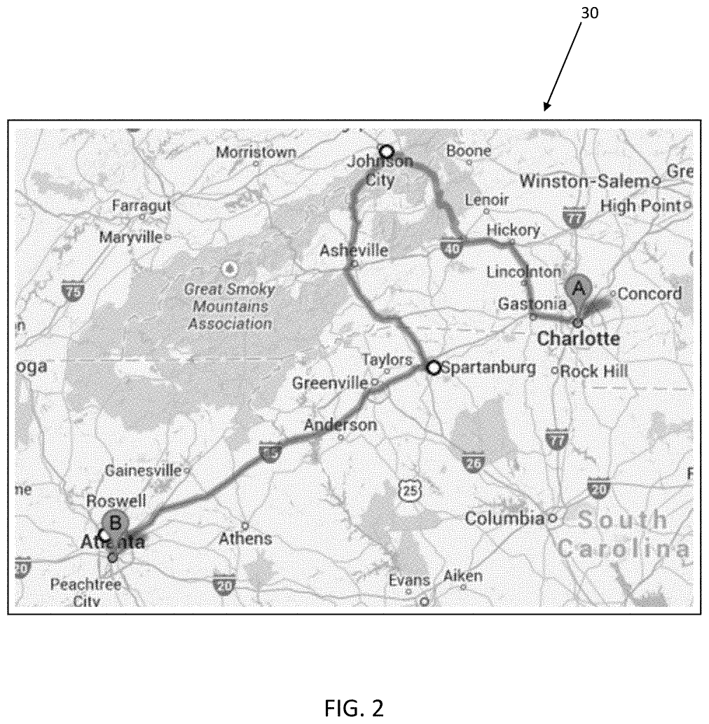

FIG. 2 is a schematic diagram illustrating the GPS and navigation map functionality 30 of the in-vehicle music system 10 (FIG. 1) of the present disclosure. Here, tagged music may be associated with different tagged GPS positions and navigation map locations, providing different location appropriate music suggestions. For example, on the map illustrated, different music suggestions may be associated with the mountains of Asheville, the city of Charlotte, the city of Atlanta, and the highway connecting these cities. These suggestions may be provided audibly and/or on the navigation map 30 itself, allowing the user to issue an appropriate voice or touch screen command to play the music, add the music to his or her playlist, and/or exclude the music from future recommendations.

It should also be noted that music characteristics can also be automatically adjusted based on observed environmental context. For example, bass and treble can be adjusted similar to volume based on identified conditions, thereby also enhancing the user experience.

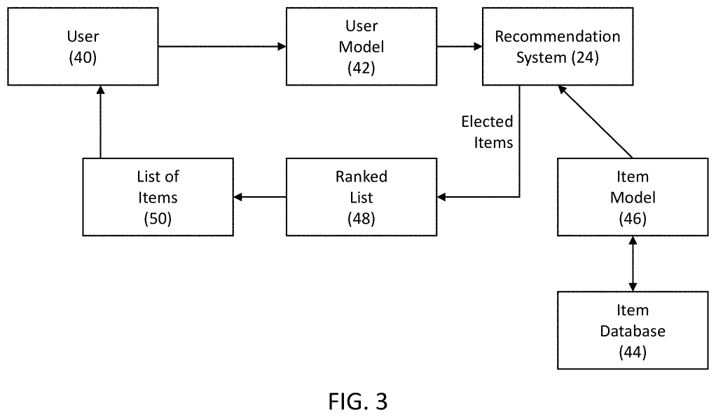

FIG. 3 is a schematic diagram illustrating the recommendation system functionality of the in-vehicle music system 10 (FIG. 1) of the present disclosure. In terms of the AI-based personalized playlist, the process starts with a user 40 that is associated with a user model 42. This user model 42 includes the user playlist 24 (FIG. 1), optionally obtained from a user mobile device, past history, or the like, indicating the users preferred music and potentially other indicated preferences as well, such as types of music the user 40 likes or dislikes, instances in which the user 40 would like to hear more or less music, etc. This information is provided to the recommendation system 24, which makes further music and preference suggestions based on an item database 44 and an item model 46, likely including lists of tagged music and rules for making suggestions, controlling the volume, controlling music characteristics, etc. Based on an observed and identified environmental context, the recommendation system 24 makes suggested additions to the user's playlist 24 in the form of suggested music (or other audio content) to be played. It should be noted here that, “music” broadly encompasses any audio content, including talk radio, audio books, audio stories, and the like. For example, the recommendation system 24 may make position and/or context appropriate talk radio and audio story suggestions. Suggestions are provided to the user via audio prompts, the GUI, and/or the navigation map 30 (FIG. 2). The user 40 then selects preferred music or content from the suggestions, or creates a ranked list 48 of what he or she would like to hear and add to or remove from his or her playlist 24, thereby playing the music or content and expanding or contracting the playlist 24 with a list of items 50. The AI system 20 not only learns from the environmental context, but also from ongoing user selections and rejections, becoming more adept at making suggestions under given sets of circumstances with respect to a given user 40.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

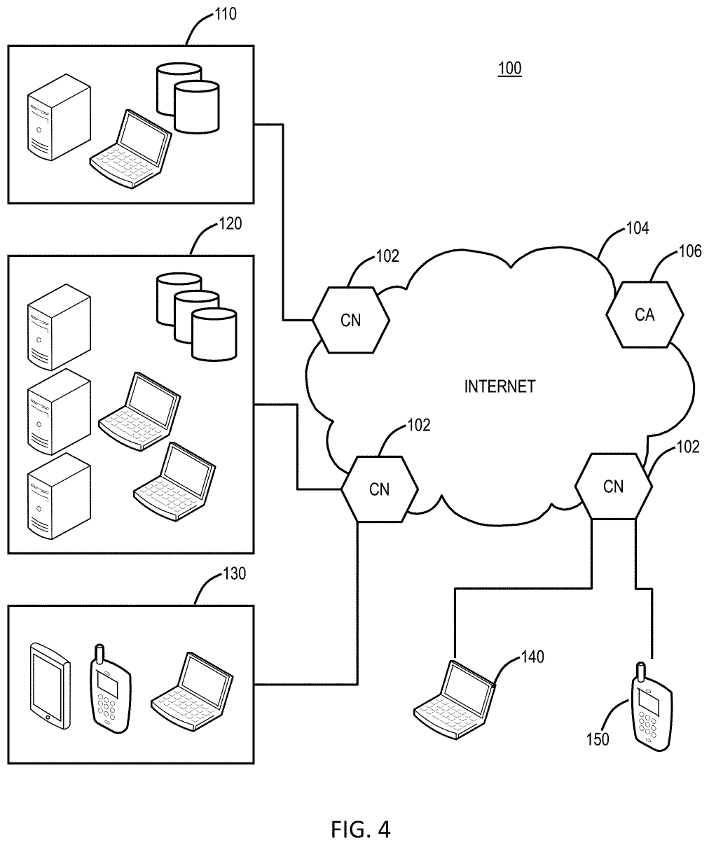

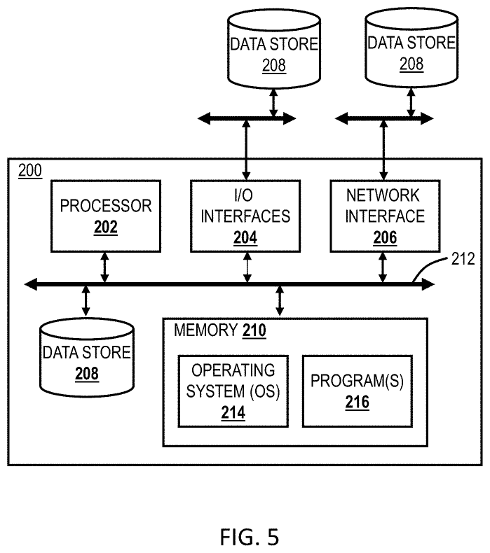

FIG. 4 is a network diagram of a cloud-based system 100 for implementing various cloud-based services of the present disclosure. The cloud-based system 100 includes one or more cloud nodes (CNs) 102 communicatively coupled to the Internet 104 or the like. The cloud nodes 102 may be implemented as a server 200 (as illustrated in FIG. 5) or the like and can be geographically diverse from one another, such as located at various data centers around the country or globe. Further, the cloud-based system 100 can include one or more central authority (CA) nodes 106, which similarly can be implemented as the server 200 and be connected to the CNs 102. For illustration purposes, the cloud-based system 100 can connect to a regional office 110, headquarters 120, various employee's homes 130, laptops/desktops 140, and mobile devices 150, each of which can be communicatively coupled to one of the CNs 102. These locations 110, 120, and 130, and devices 140 and 150 are shown for illustrative purposes, and those skilled in the art will recognize there are various access scenarios to the cloud-based system 100, all of which are contemplated herein. The devices 140 and 150 can be so-called road warriors, i.e., users off-site, on-the-road, etc. The cloud-based system 100 can be a private cloud, a public cloud, a combination of a private cloud and a public cloud (hybrid cloud), or the like.

Again, the cloud-based system 100 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 110, 120, and 130 and devices 140 and 150. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 100 is illustrated herein as one example embodiment of a cloud-based system, and those of ordinary skill in the art will recognize the systems and methods described herein are not necessarily limited thereby.

FIG. 5 is a block diagram of a server 200, which may be used in the cloud-based system 100 (FIG. 4), in other systems, or stand-alone. For example, the CNs 102 (FIG. 4) and the central authority nodes 106 (FIG. 4) may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 4 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but is not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104 (FIG. 4). The network interface 206 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., a SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable medium having computer-readable code stored thereon for programming a computer, server, appliance, device, processor, circuit, etc. each of which may include a processor to perform functions as described and claimed herein. Examples of such computer-readable mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

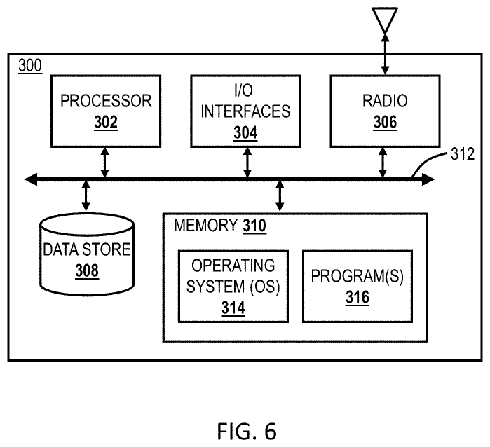

FIG. 6 is a block diagram of a user device 300, which may be used in the cloud-based system 100 (FIG. 4), as part of a network, or stand-alone. Again, the user device 300 can be a vehicle, a smartphone, a tablet, a smartwatch, an Internet of Things (IoT) device, a laptop, a virtual reality (VR) headset, etc. The user device 300 can be a digital device that, in terms of hardware architecture, generally includes a processor 302, I/O interfaces 304, a radio 306, a data store 308, and memory 310. It should be appreciated by those of ordinary skill in the art that FIG. 5 depicts the user device 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 can be, for example, but is not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 306 enables wireless communication to an external access device or network. Any number of suitable wireless data communication protocols, techniques, or methodologies can be supported by the radio 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

Again, the memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 6, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network, such as the cloud-based system 100 (FIG. 4).

Again, the present disclosure provides an in-vehicle music system and method that leverages current external cameras, interior cameras, interior microphones, GPS and navigation maps, AI systems, and the like to provide driving pace-adapted music, external location, scene, weather, and road condition-adapted music, interior noise-adapted music, driver mood-adapted music, and big data-trained personalized playlists taking these functionalities into account.

Although the present disclosure is illustrated and described herein with reference to illustrative embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A system, comprising:
an external camera coupled to a vehicle;
an interior camera coupled to the vehicle;
an interior microphone coupled to the vehicle;
an artificial intelligence system coupled to the external camera, the interior camera, and the interior microphone operable for determining one or more of an environmental context surrounding the vehicle, an occupant state inside the vehicle, and a noise condition inside the vehicle based on one or more of an external image obtained from the external camera, an interior image obtained from the interior camera, and a sound signal obtained from the interior microphone; and
a recommendation system operable for making a music suggestion and controlling a volume of a sound system of the vehicle based on the one or more of the environmental context surrounding the vehicle, the occupant state inside the vehicle, and the noise condition inside the vehicle determined by the artificial intelligence system.

2. The system of claim 1, further comprising a global positioning and navigation system coupled to the vehicle, wherein the recommendation system is further operable for making the music suggestion and controlling the volume of the sound system of the vehicle based on a position of the vehicle determined by the global positioning and navigation system.

3. The system of claim 1, wherein the recommendation system is operable for making the music suggestion based on the one or more of the environmental context surrounding the vehicle, the occupant state inside the vehicle, and the noise condition inside the vehicle using one or more of tagged music from an occupant playlist and a public playlist.

4. The system of claim 1, wherein the recommendation system is further operable for receiving an acceptance or rejection of the music suggestion made by the recommendation system via one or more of an audible occupant command and an occupant command entered using a graphical user interface.

5. The system of claim 4, wherein the recommendation system is further operable for playing the music suggestion via the sound system if accepted by an occupant.

6. The system of claim 4, wherein the recommendation system is further operable for adding the music suggestion to an occupant playlist if accepted by an occupant.

7. The system of claim 1, wherein the artificial intelligence system comprises a trained neural network.

8. A method, comprising:
obtaining an external image using an external camera coupled to a vehicle;
obtaining an interior image using an interior camera coupled to the vehicle;
obtaining an audio signal using an interior microphone coupled to the vehicle;
determining one or more of an environmental context surrounding the vehicle, an occupant state inside the vehicle, and a noise condition inside the vehicle based on one or more of the external image obtained from the external camera, the interior image obtained from the interior camera, and the sound signal obtained from the interior microphone using an artificial intelligence system coupled to the external camera, the interior camera, and the interior microphone; and
making a music suggestion and controlling a volume of a sound system of the vehicle based on the one or more of the environmental context surrounding the vehicle, the occupant state inside the vehicle, and the noise condition inside the vehicle determined by the artificial intelligence system using a recommendation system.

9. The method of claim 8, further comprising making the music suggestion and controlling the volume of the sound system of the vehicle using the recommendation system based on a position of the vehicle determined by a global positioning and navigation system coupled to the vehicle.

10. The method of claim 8, further comprising making the music suggestion based on the one or more of the environmental context surrounding the vehicle, the occupant state inside the vehicle, and the noise condition inside the vehicle using the recommendation system and one or more of tagged music from an occupant playlist and a public playlist.

11. The method of claim 8, further comprising receiving an acceptance or rejection of the music suggestion made by the recommendation system via one or more of an audible occupant command and an occupant command entered using a graphical user interface.

12. The method of claim 11, further comprising playing the music suggestion via the sound system if accepted by an occupant.

13. The method of claim 11, further comprising adding the music suggestion to an occupant playlist if accepted by an occupant.

14. A non-transitory computer-readable medium comprising instructions stored in a memory and executed by a processor to carry out the steps, comprising:
obtaining an external image using an external camera coupled to a vehicle;
obtaining an interior image using an interior camera coupled to the vehicle;
obtaining an audio signal using an interior microphone coupled to the vehicle;
determining one or more of an environmental context surrounding the vehicle, an occupant state inside the vehicle, and a noise condition inside the vehicle based on one or more of the external image obtained from the external camera, the interior image obtained from the interior camera, and the sound signal obtained from the interior microphone using an artificial intelligence system coupled to the external camera, the interior camera, and the interior microphone; and
making a music suggestion and controlling a volume of a sound system of the vehicle based on the one or more of the environmental context surrounding the vehicle, the occupant state inside the vehicle, and the noise condition inside the vehicle determined by the artificial intelligence system using a recommendation system.

15. The non-transitory computer-readable medium of claim 14, the steps further comprising making the music suggestion and controlling the volume of the sound system of the vehicle using the recommendation system based on a position of the vehicle determined by a global positioning and navigation system coupled to the vehicle.

16. The non-transitory computer-readable medium of claim 14, the steps further comprising making the music suggestion based on the one or more of the environmental context surrounding the vehicle, the occupant state inside the vehicle, and the noise condition inside the vehicle using the recommendation system and one or more of tagged music from an occupant playlist and a public playlist.

17. The non-transitory computer-readable medium of claim 14, the steps further comprising receiving an acceptance or rejection of the music suggestion made by the recommendation system via one or more of an audible occupant command and an occupant command entered using a graphical user interface.

18. The non-transitory computer-readable medium of claim 17, the steps further comprising playing the music suggestion via the sound system if accepted by an occupant.

19. The non-transitory computer-readable medium of claim 17, the steps further comprising adding the music suggestion to an occupant playlist if accepted by an occupant.

20. The non-transitory computer-readable medium of claim 14, wherein the artificial intelligence system comprises a trained neural network.
